(19) United States
(12) Patent Application Publication
(10) Pub. No.: US 2024/0120781 A1
(43) Pub. Date: Apr. 11, 2024

(54) STATOR COOLING

(71) Applicant: Cummins Inc., Columbus, IN (US)

(72) Inventors: Shaohong Zhu, Columbus, IN (US); Richard Barden, Columbus, IN (US); Krzysztof Paciura, Columbus, IN (US)

(21) Appl. No.: 18/377,170

(22) Filed: Oct. 5, 2023

(30) Foreign Application Priority Data
Oct. 7, 2022 (GB) 2214729.2

(51) Int. Cl. H02K 1/20; H02K 1/16; H02K 3/04

(52) U.S. Cl. CPC H02K 1/20; H02K 1/165; H02K 3/04; H02K 15/02

(57) ABSTRACT

A stator for an electrical machine includes a stator yoke and a plurality of stator teeth extending radially inwards from the stator yoke, the stator teeth defining stator slots for stator windings. A plurality of auxiliary teeth extend radially inwards from the stator yoke into the stator slots. At least some of the auxiliary teeth comprise cooling channels. A conduit is arranged to carry coolant circumferentially around the stator and into the cooling channels in the auxiliary teeth.

### CROSS-REFERENCE TO RELATED APPLICATION

The present application claims the benefit of U.K. Patent Application No. 2214729.2, filed Oct. 7, 2022, the disclosure of which is incorporated herein in its entirety for all purposes.

### FIELD

The present disclosure relates to a stator for an electrical machine, and in particular a stator which can facilitate cooling while maintaining ease of manufacture. The present disclosure has particular application with stators having an open slot design with concentrated windings. The stator may be, for example, the stator of a motor/generator for automotive applications.

### BACKGROUND

Rotating electrical machines, such as motors and generators, comprise a rotor and a stator separated by an airgap. Typically, the stator comprises a stator core with a plurality of teeth extending radially inwards. The teeth define a plurality of slots for accommodating stator windings. The rotor is typically arranged to rotate inside the stator, with rotor poles facing the stator windings.

In known electrical machines, the stator windings may be either distributed or concentrated. In the case of distributed windings, each coil of the windings is distributed over two or more stator teeth. In the case of concentrated windings, each coil is wound on one tooth. Concentrated windings may provide various advantages in terms of ease of manufacture, as well as power/torque density and fault tolerance. For example, it may be possible to slide pre-formed coils onto the stator teeth rather than winding them in situ. However, this requires the stator to have an open slot design, with sufficient clearance between the teeth to allow the coils to be inserted.

Efforts have been made to operate electrical machines, particularly those for automotive applications, at increasing high speeds and electrical frequencies, in pursuit of weight and volume reduction. However, this may lead to increased AC losses in the stator windings. The AC losses are due amongst other things to phenomena known as the skin effect and the proximity effect. The AC losses may reduce the efficiency of the machine and create challenges in terms of heat dissipation, potentially leading to overheating of the machine.

It has been proposed to replace the conventional random wires in stator windings with flat rectangular conductors. The flat rectangular conductors have a cross section with a relatively high aspect ratio. This may help to reduce AC losses, by reducing the influence of the skin effect.

Electrical machines with an open-slot stator design using pre-formed coils of flat rectangular wire may therefore provide various advantages in terms of ease of manufacture and reduction in AC losses, as well as a high power/torque density and good fault tolerance. However, further improvements in heat dissipation would be desirable.

### SUMMARY

According to one aspect of the present disclosure there is provided a stator for an electrical machine, the stator comprising:
a stator yoke;
a plurality of stator teeth extending radially inwards from the stator yoke, the stator teeth defining stator slots;
a plurality of pre-formed coils, wherein each coil is arranged to be slid onto one of the stator teeth; and
a plurality of auxiliary teeth, wherein each auxiliary tooth extends radially inwards from the stator yoke into a stator slot between the coils of two adjacent stator teeth.

The present disclosure may provide the advantage that, by providing auxiliary teeth which extend radially inwards into a stator slot between the coils of two adjacent stator teeth, a heat transfer path can be provided from the windings, which may allow a better heat dissipation to be achieved, while maintaining ease of manufacture.

The auxiliary teeth in some examples are arranged to be in thermal contact with the coils. For example, the auxiliary teeth may be in direct contact with the coils, or may be in contact with the coils via a thermally conductive medium such as thermally conductive paper or a thermally conductive former. This may help to achieve a heat transfer path from the coils through the auxiliary teeth, for example, to the stator yoke.

The auxiliary teeth may have sides which run parallel to the sides of the coils. For example, the auxiliary teeth may have sides which run alongside (for example, in contact with or in close proximity to) the sides of the coils. This may help to maximise the area of contact between the coils and the auxiliary teeth, thereby helping to ensure a good transfer of heat between the coils and the auxiliary teeth.

The auxiliary teeth may have a width (in a circumferential direction) which decreases with increasing distance into the stator slot from the stator yoke. For example, the auxiliary teeth may have a triangular or trapezoidal shape in axial cross-section. In this case, the teeth may have a base at the point where they meet the stator yoke, and may narrow to an apex at a point inside the slot. This may help to ensure that the sides of the auxiliary teeth run parallel to the sides of the coils.

The auxiliary teeth may extend at least 20%, 30%, 40% or 50% into a stator slot in a radial direction (from the stator yoke to the slot opening). For example, in one embodiment, the auxiliary teeth may extend approximately 60% in a stator slot, although other values may be used instead. The auxiliary teeth may extend along at least 30%, 40%, 50% or 60% of a coil in a radial direction. For example, in one embodiment, the auxiliary teeth may extend along approximately 70% of a coil, although other values may be used instead.

In some examples, each auxiliary tooth substantially fills a (circumferential) gap between the coils of two adjacent teeth, for example over a distance extending at least part way into a stator slot. This may help to ensure a good transfer of heat between the coils and the auxiliary teeth.

In some examples, the stator slots have an open slot design. For example, the stator teeth may have a width at the slot opening which is substantially the same as the width of the teeth elsewhere. In some examples, each stator tooth has parallel sides.

This may allow the pre-formed coils of stator windings to be slid onto the stator teeth.

In some examples, the pre-formed coils form concentrated stator windings, such that each coil is wound on one tooth. This may provide advantages in terms of ease of manufacture, power/torque density, heat dissipation and/or fault tolerance.

In general, the pre-formed coils may comprise any suitable electrical conductor, such as electrical wire, which may have any appropriate cross-section, such as round or any other shape. However, in a preferred embodiment, the pre-formed coils comprise coils of rectangular wire, that is, wire having a rectangular cross-section. In this case, the wire may have a depth (in a radial direction relative to the axis of the machine) which is less than its width (in a circumferential direction). This may help to reduce skin effect losses for a wire with a given cross-sectional area. Furthermore, rectangular wires may facilitate assembly and may help with the slot fill factor.

In some examples, the wire is flat rectangular wire, that is, wire with a relatively high aspect ratio (ratio of width to depth). For example, the wire may have an aspect ratio of at least 1.4:1, 2:1, 3:1, 4:1 or 5:1, or any other appropriate ratio.

In some examples, each coil comprises a plurality of turns of rectangular wire. In one embodiment, each turn comprises a single width of rectangular wire. In this case, the thickness of the coil (from an inside surface to an outside surface) may be equivalent to the width of the rectangular wire. This may help to maximize the cross-sectional area of the wire, thereby helping to minimize current density, while at the same time helping to reduce skin effect losses. However, the preformed coils can allow each turn to comprise multiple rectangular wires. In this case, a plurality of strands of rectangular wire could be used in each turn.

In some examples, each of the coils comprises an input terminal and an output terminal. In this case, an output terminal on one coil may be connected to an input terminal on another coil using a connector. The connector may be, for example, a wire, a jump lead, or a strip of metal, or a connection ring, or any other suitable type of connector. This may facilitate connection of the coils in an appropriate winding configuration.

The stator yoke in some examples may be an annular yoke, and may be part of a stator core, which may also comprise the stator teeth and the auxiliary teeth.

The auxiliary teeth in some examples may be arranged to conduct heat from the coils to the stator yoke. In this case, the stator yoke may be arranged to dissipate heat. For example, the stator may comprise a cooling jacket arranged to cool the stator yoke. The cooling jacket may be provided around the outside of the stator yoke and may for example convey a liquid coolant in order to remove heat from the stator yoke. Alternatively, or in addition, the stator yoke itself may comprise cooling channels and/or cooling fins. Heat may also be conducted through the stator teeth to the stator yoke.

It has been found pursuant to the present disclosure that the auxiliary teeth themselves can be provided with cooling channels. Thus, in a preferred embodiment, at least some of the auxiliary teeth comprise cooling channels.

By providing cooling channels in the auxiliary teeth, it may be possible to locate the cooling channels in areas which are close to the coils, and which thus minimise the heat transfer paths, thereby helping with cooling. Furthermore, the cooling channels may be provided in areas which are not overlapped by the coils, thereby facilitating the transfer of coolant into and out of the cooling channels (for example using fluid conduits). In addition, by providing the cooling channels in the auxiliary teeth, it may be possible to locate the cooling channels in areas which are not substantially in the stator's magnetic flux paths (which typically are primarily through the stator yoke and the stator teeth where the coils are wound), thereby helping to minimize flux leakage. Thus, providing cooling channels in the auxiliary teeth may allow additional cooling to be achieved, without significantly impacting other parts of the stator.

This aspect of the disclosure may also be provided independently. Thus, according to another aspect of the disclosure, there is provided a stator for an electrical machine, the stator comprising:
a stator yoke;
a plurality of stator teeth extending radially inwards from the stator yoke, the stator teeth defining stator slots for stator windings; and
a plurality of auxiliary teeth extending radially inwards from the stator yoke into the stator slots;
wherein at least some of the auxiliary teeth comprise cooling channels.

The stator yoke, stator teeth, auxiliary teeth and/or stator windings may be in any of the forms described above.

The cooling channels in some examples may run axially through the auxiliary teeth. This may allow a coolant to flow through the stator from one side to the other, or from the middle of the stator core to the two sides. The cooling channels may be arranged to convey a liquid coolant, although other types of coolant could be used instead.

The stator may further comprise means for conveying coolant into and/or out of the cooling channels. For example, the stator may comprise a conduit for introducing coolant to the cooling channels and/or a conduit for receiving coolant from the cooling channels. Each conduit may comprise, for example, a pipe and a plurality of ports. In this case, the ports may be arranged to introduce coolant into and/or receive coolant from the cooling channels. The conduits may be connected to a cooling circuit for circulating coolant through the machine.

In another embodiment, the stator yoke may comprise a cooling passage for introducing coolant into the cooling channels. The cooling passage may be provided at the centre of the stator yoke axially, or elsewhere, and may run circumferentially around the outside of the stator yoke. The cooling passage in some examples may be in fluid communication with the cooling channels in the auxiliary teeth. This may provide a convenient and space efficient way of introducing coolant into the cooling channels. Furthermore, if the cooling passage is provided at the centre of the stator yoke axially, it may be possible to introduce the coolant into the stator yoke in an area where temperatures are likely to be the highest.

The cooling passage may be in the form of an annular trough in the outside of the stator yoke. For example, a group of laminations at the centre (axially) of the stator core may be provided, in which group the outside diameter of the stator yoke is less than that of the other laminations. Alternatively, a separate ring made from an electrically and/or magnetically non-conductive material could be provided at the centre of the stator core, between groups of laminations. In this case the ring may have an outside diameter which is less than that of the laminations, in order to form the cooling passage.

Coolant may be introduced into the cooling passage using a conduit such as a hose or pipe. Coolant flowing into the cooling channels from the cooling passage may flow axially through the stator core towards each end of the stator. Coolant exiting the cooling channels may flow through the interior of the stator and be collected in a sump. Alternatively, coolant exiting the cooling channels may be collected by a conduit such as a pipe and/or ports.

If desired, it would be possible for the stator to comprise a cooling jacket and/or cooling channels in the stator yoke. However, in some circumstances, it may be possible for sufficient cooling to be achieved using cooling channels in the auxiliary teeth. In this case, cooling may be achieved without the additional size and complexity of a cooling jacket or a stator yoke with cooling channels (or with a smaller sized cooling jacket and/or stator yoke). Thus, this arrangement may allow cooling to be achieved with a compact machine design.

In a preferred embodiment, the stator comprises a stator core formed from a plurality of stacked laminations. In this case, the auxiliary teeth may be formed from the same laminations as the stator yoke and/or the stator teeth. For example, the auxiliary teeth may be produced from the same sheet of raw material as the stator yoke and/or as part of the same stamping process. This may facilitate manufacture and may allow the auxiliary teeth to be formed from part of the raw material that would otherwise be scrap.

Where cooling channels are provided in the auxiliary teeth, these may also be produced as part of the same process. For example, the cooling channels may be stamped in the teeth as part of the process of stamping the laminations. This may allow the cooling channels to be formed without requiring a separate step of forming the cooling channels. However, it would also be possible for the cooling channels to be formed in the auxiliary teeth after the laminations have been stamped, for example by drilling or machining.

Alternatively or in addition it would be possible for at least some of the auxiliary teeth to be a separate component. For example, separate auxiliary teeth could be added to a stator slot after the stator core has been formed and/or after the stator coils have been inserted. The separate auxiliary teeth in some examples may be arranged to be in thermal contact with the stator yoke and the coils. The separate auxiliary teeth could be made from the same material as the stator core, or from a different material. For example, it would be possible for the separate auxiliary teeth to be made from a material with a high thermal conductivity, such as a ceramic material.

Where cooling channels are provided in the auxiliary teeth, the cooling channels may be provided with fins extending into the cooling channels. The fins may be formed as part of the process of stamping laminations, or they may be added later. The fins may help to improve the transfer of heat from the auxiliary teeth to a cooling fluid flowing through the cooling channels.

According to another aspect of the disclosure there is provided a rotating electrical machine comprising a rotor and a stator in any of the forms described above.

The machine may further comprise a cooling circuit for circulating coolant through the machine. For example, where the auxiliary teeth comprise cooling channels, the machine may further comprise a cooling circuit for circulating coolant through the cooling channels.

Corresponding methods may also be provided. Thus, according to another aspect of the disclosure there is provided a method of manufacturing a stator for an electrical machine, the method comprising:
forming a stator core, the stator core comprising a stator yoke, a plurality of stator teeth defining stator slots, and a plurality of auxiliary teeth, each auxiliary tooth extending radially inwards from the stator yoke into a stator slot; and
sliding preformed coils onto the stator teeth;
wherein each auxiliary tooth extends between the coils of two adjacent stator teeth.

The method may comprise forming cooling channels in the auxiliary teeth.

In some examples, the stator core is formed from a plurality of stacked laminations. The laminations may be stamped from a sheet of raw material. In this case, the auxiliary teeth may be produced as part of the same stamping process. Furthermore, where the auxiliary teeth comprise cooling channels, the cooling channels may be produced as part of the stamping process.

According to another aspect of the disclosure there is provided a stator for an electrical machine, the stator comprising:
a stator yoke;
a plurality of stator teeth extending radially inwards from the stator yoke, the stator teeth defining stator slots for stator windings; and
a plurality of auxiliary teeth extending radially inwards from the stator yoke into the stator slots, wherein at least some of the auxiliary teeth comprise cooling channels; and
a conduit arranged to carry coolant circumferentially around the stator and into the cooling channels in the auxiliary teeth.

This aspect of the disclosure may allow coolant can be conveyed around the stator and then introduced into the cooling channels in areas which are not overlapped by the stator windings. This may provide a convenient and space efficient way of introducing coolant into the cooling channels. Furthermore, if the cooling passage is provided at the centre of the stator yoke axially, it may be possible to introduce the coolant into the stator yoke in an area where temperatures are likely to be the highest. In addition, the cooling channels may be located in areas which are not substantially in the stator's magnetic flux paths, which may help to avoid any negative impact on the machine's electromagnetic performance.

The cooling passage in some examples may be in fluid communication with the cooling channels in the auxiliary teeth. The stator yoke, stator teeth, auxiliary teeth, stator windings and/or other parts of the stator or electrical machine may be in any of the forms described above.

The stator windings may comprise a plurality of pre-formed coils, and each coil may be arranged to be slid onto one of the stator teeth. Alternatively, coils may be wound on the stator teeth in situ. In either case, each auxiliary tooth may extend radially inwards from the stator yoke into a stator slot between the coils of two adjacent stator teeth.

In one embodiment, the conduit may comprise a pipe and a plurality of ports. For example, the pipe may be arranged to carry coolant circumferentially around the stator, and the ports may be arranged to carry coolant from the pipe into the cooling channels in the auxiliary teeth.

In another embodiment, the conduit may comprise a cooling passage in the stator yoke. In this case, the cooling passage may run circumferentially around the outside of the stator yoke. For example, the cooling passage may be an annular trough in the outside of the stator yoke.

In one embodiment, the cooling passage is located at or towards the centre, axially, of the stator yoke. For example, the cooling passage may be located at greater than 25%, 30%, 35%, 40% or 45% and/or less than 75%, 70%, 65%, 60% or 55% of the way through the stator yoke axially, although other values may be used instead. In general, the centre of the stator yoke is likely to experience the greatest rise in temperature. Thus, by providing the cooling passage at or towards the centre of the stator yoke, it may be possible to introduce coolant into an area of the stator yoke which is likely to experience the highest temperatures. This in turn may help to ensure effective cooling of the stator.

The stator may comprise a plurality of stacked stator laminations, in which case the cooling passage may be formed by providing a group of stator laminations with an outside diameter which is less than that of other stator laminations. Alternatively or in addition, the cooling passage may be formed by providing a ring of material between two groups of stator laminations, the ring of material having an outside diameter which is less than that of the laminations. The ring of material may comprise an electrically and magnetically non-conductive material. For example, in one embodiment the ring of material may be at least partially made from a thermoplastic polymer, such as a polyether ether ketone (PEEK) material, although any other suitable material or materials could be used instead.

The cooling passage may be arranged to carry coolant circumferentially around the stator yoke and the cooling channels may be arranged to carry coolant axially through the auxiliary teeth. For example, coolant may flow circumferentially around the stator yoke through the cooling passage, then radially inwards towards a cooling channel in an auxiliary tooth, then axially through the cooling channel. When in a cooling channel, the coolant may flow axially outwards in both directions (for example, from the centre of a cooling channel, axially outwards in both directions). The coolant may exit the cooling channel at both ends, axially, of the stator. Coolant exiting a cooling channel may be collected using for example a sump and/or a pipe and a plurality of ports.

According to another aspect of the disclosure there is provided a rotating electrical machine comprising a stator in any of the forms described above and a cooling circuit for circulating coolant through the cooling channels.

According to another aspect of the disclosure there is provided a method of manufacturing a stator for an electrical machine, the method comprising:
forming a stator core, the stator core comprising a stator yoke, a plurality of stator teeth defining stator slots, and a plurality of auxiliary teeth, each auxiliary tooth extending radially inwards from the stator yoke into a stator slot, wherein at least some of the auxiliary teeth comprise cooling channels; and
providing a conduit arranged to carry coolant circumferentially around the stator and into the cooling channels in the auxiliary teeth.

Features of one aspect of the disclosure may be provided with any other aspect. Apparatus features may be provided with method aspects and vice versa.

In the present disclosure, terms such as “radially”, “axially”, “tangentially” and “circumferentially” are generally defined with reference to the axis of rotation of the electrical machine, unless the context implies otherwise.

### BRIEF DESCRIPTION OF THE DRAWINGS

Preferred embodiments of the present disclosure will now be described, purely by way of example, with reference to the accompanying drawings, in which:

FIG. 1 is a cross-section through part of a known rotating electrical machine;

FIG. 2 shows a pre-formed coil of flat rectangular wire;

FIG. 3 shows part of a stator with pre-formed coils of flat rectangular wire;

FIG. 4 shows a cross-section through part of a stator in an embodiment of the disclosure;

FIG. 5 shows part of a stator with a cooling jacket in an embodiment of the disclosure;

FIG. 6 shows part of a stator in another embodiment of the disclosure;

FIG. 7 shows part of a stator in another embodiment of the disclosure;

FIG. 8 shows part of a stator in a further embodiment of the disclosure;

FIG. 9 shows part of a stator and part of a cooling circuit in embodiment of the disclosure;

FIG. 10 is a cross-section through part of the stator core in the arrangement of FIG. 9;

FIG. 11 shows a stator and cooling circuit in an embodiment of the disclosure;

FIG. 12 shows steps which may be carried out to manufacture a stator in one embodiment;

FIG. 13 shows a partially assembled stator;

FIG. 14 shows part of a stator in another embodiment of the disclosure;

FIG. 15 shows an example of a stator lamination which may be used to form a cooling passage;

FIG. 16 shows an example of a solid ring which may be used to form a cooling passage;

FIG. 17 illustrates how a stator housing can be used to form an outer wall of a cooling passage; and

FIG. 18 shows an alternative arrangement with a pipe located in the cooling passage.

### DETAILED DESCRIPTION

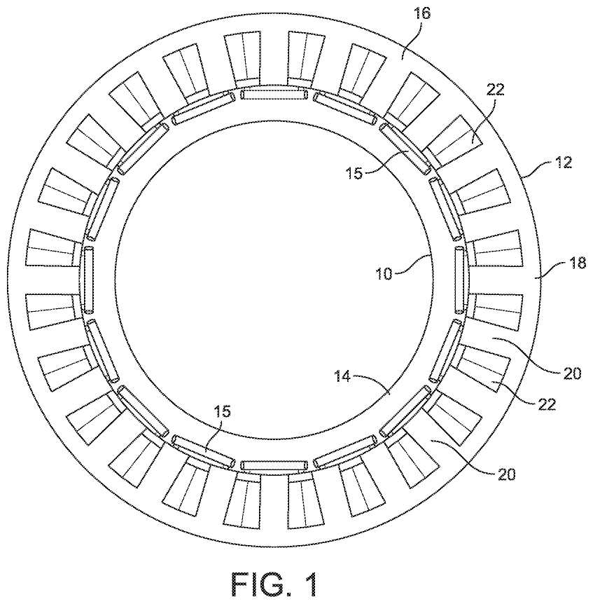

FIG. 1 is a cross-section through part of a known rotating electrical machine. Referring to FIG. 1, the machine comprises a rotor 10 inside a stator 12, with an airgap between the two. The rotor 10 comprises a rotor core 14 with embedded permanent magnets 15. The stator 12 comprises a stator core 16 comprising an annular stator yoke 18 with a plurality of stator teeth 20 which project radially inwards. The teeth 20 define slots which accommodate stator windings 22. The stator windings 22 are in the form of coils located on the teeth 20. The coils may be pre-formed coils which are slid onto the teeth. The machine may be, for example, a three-phase fractional slot concentrated winding (FSCW) permanent magnet synchronous machine. Such machines are often used in automotive applications due to their high efficiency, high torque density, ease of manufacture and fault tolerance capability. In the example shown, the stator comprises twenty-four stator teeth 20 and the rotor comprises sixteen permanent magnets 15. However, it will be appreciated that any appropriate number of stator teeth and rotor magnets may be provided.

In operation, the rotor 10 rotates inside the stator 12 about a central axis of rotation. A magnetic flux developed by the permanent magnets 15 crosses the airgap and combines with the stator windings 22. In the case of motor operation, a varying electrical current is supplied to the stator windings 22 and the thus generated magnetic field causes the rotor to rotate. In the case of generator operation, the rotor is rotated by a prime mover and the rotating magnetic field developed by the permanent magnets 15 causes an electrical current to flow in the stator windings. The stator windings may be, for example, connected to a three-phase inverter. The rotor may be, for example, connected to a vehicle drivetrain. A cooling jacket (not shown) may be provided around the stator for circulating coolant in order to cool the machine.

Attempts have been made to operate electrical machines for automotive applications at higher speeds and higher electrical frequencies in order to achieve weight and volume reductions. However, this may lead to increased AC losses in the stator windings. The AC losses are at least partially caused by phenomena known as the skin effect and the proximity effect. The skin effect loss is associated with the non-uniform current distribution of the AC current flowing in the conductor, while the proximity effect loss is caused by the effect of the alternating field of other nearby conductors. Both loss components exist at the same time, and both affect the machine's efficiency and create localized high conductor temperature, especially at the slot opening area.

In order to reduce AC losses, it has been proposed to use flat rectangular wire to replace the traditional random windings with multiple stranded round wires. The flat rectangular wire has a cross section with a relatively high aspect ratio (ratio of width to depth), in order to reduce skin effect losses for a given cross-sectional area. The flat rectangular wire may be pre-formed into coils for insertion onto the stator teeth, in order to help with ease of manufacture. The flat rectangular wire may be, for example, as disclosed in the article “Application of Flat Rectangular Wire Concentrated Winding for AC loss Reduction in Electrical Machines”, Zhu et al, 2021 IEEE Energy Conversion Congress and Exposition, 10-14 Oct. 2021, Vancouver, Canada, the subject matter of which is incorporated herein by reference.

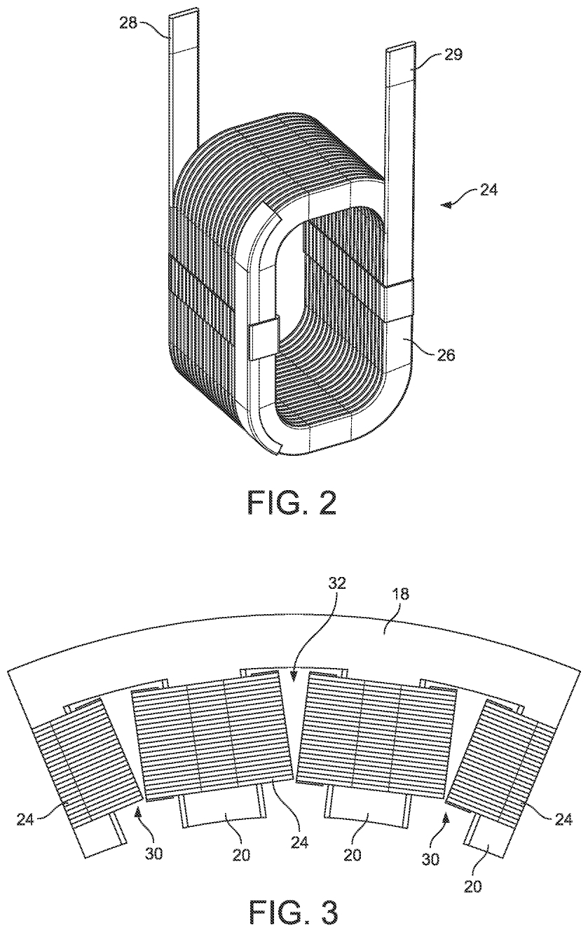

FIG. 2 shows an example of a pre-formed coil of flat rectangular wire. Referring to FIG. 2, the coil 24 comprises multiple turns of a flat rectangular wire 26. In this example, each turn of the coil 24 comprises a single width of flat rectangular wire 26. The flat rectangular wire 26 may be made from, for example, enameled copper, aluminium wire, or any other suitable material. The thickness of the coil 24 (from its inside surface to its outside surface) is equivalent to the width of the wire 26. The depth of the coil 24 (in a radial direction relative to the axis of the electrical machine) is equivalent to the depth of the wire multiplied by the number of turns. The wire has a cross section with a relatively high aspect ratio (the ratio of its width to its depth). For example, in one embodiment the width of the wire may be around 8 mm and the depth of the wire may be around 1.5 mm, although it will be appreciated that other values may be used instead, depending for example on the size of the machine.

The coil 24 also comprises an input terminal 28 and an output terminal 29. In this example, the input terminal 28 is located at one side of the coil and the output terminal 29 is located at the other side, circumferentially. The input terminal 28 extends in an axial direction (parallel to the axis of the machine) at the radially outwards end of the coil, while the output terminal 29 extends in an axial direction at the radially inwards end of the coil. if desired, it would also be possible for either or both of the input terminal and the output terminal to be bent forwards or backwards before extending axially outwards, to facilitate interconnectivity.

The coil 24 is pre-formed for insertion onto a stator tooth. If desired, the coil 24 may be provided on a bobbin or a former which is also slid onto the tooth. Alternatively, the coil 24 may be slid directly onto the tooth, or a barrier such as electrically insulating paper may be provided between the tooth and the coil.

FIG. 3 shows part of a stator with pre-formed coils of flat rectangular wire. In the interests of clarity, only part of the stator is shown. However, it will be appreciated that the complete stator is generally annular in the manner shown in FIG. 1. Referring to FIG. 3, the stator comprises a stator yoke 18 and a plurality of teeth 20 defining stator slots 30. The stator has an open slot design, that is, the slots are open to allow the radial insertion of the coils onto the teeth. The width of the teeth corresponds to the internal diameter of the coils.

In the arrangement of FIG. 3, each tooth 20 has parallel sides, to allow a coil to be slid along it in a radial direction. As a consequence, the sides of adjacent coils 24 lie at a (non-zero) angle to each other. This creates a gap 32 between two adjacent coils. The width of the gap 32 increases with increasing distance radially into the slot, towards the stator yoke 18.

In conventional machines, gaps between the coils are filled with a potting compound such as epoxy. However, in embodiments of the disclosure, the gap 32 is used to help dissipate heat from the coils.

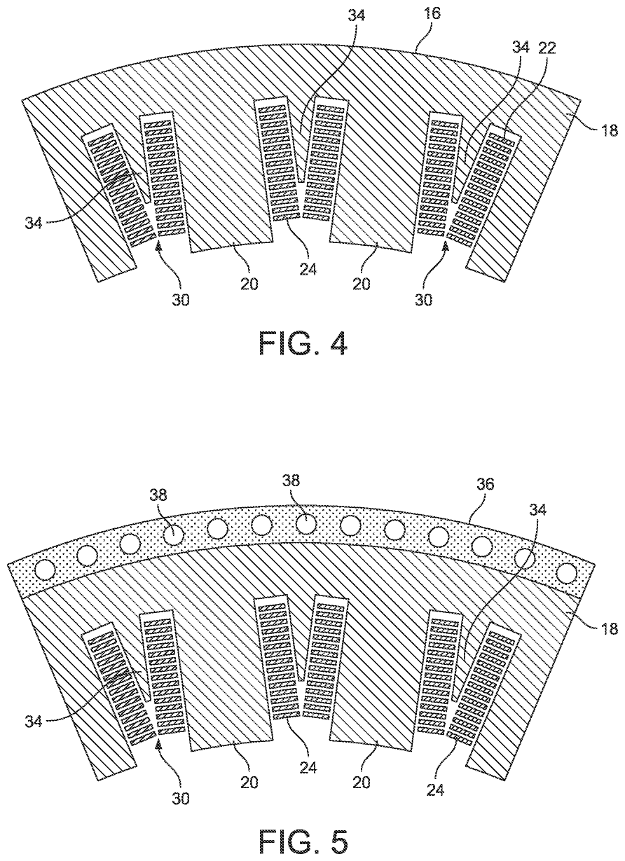

FIG. 4 shows a cross-section through part of a stator in an embodiment of the disclosure. Referring to FIG. 4, the stator comprises a stator core 16 and stator windings 22. The stator core 16 comprises a stator yoke 18 and a plurality of stator teeth 20 extending radially inwards from the stator yoke. The stator teeth 20 define slots 30 for the stator windings. The stator windings are in the form of pre-formed coils 24 which are slid onto the stator teeth 20. The stator teeth 20 have parallel sides to allow the coils 24 to be slid onto them. Thus, the width of a tooth 20 (in a tangential direction) is substantially constant and is slightly less than the inside diameter of a coil 24. The stator slots 30 are open to allow insertion of the coils 24. Sufficient space is left between the tips of adjacent teeth to allow the coils to be inserted. In particular, sufficient space is provided to allow a coil to be slid radially onto a tooth even if a coil is already present on an adjacent tooth.

In the embodiment of FIG. 4, the stator core 16 also comprises a plurality of auxiliary teeth 34. The auxiliary teeth 34 extend from the stator yoke 18 radially inwards into the slots 30. Each auxiliary tooth 34 extends part-way through the slot 30 from the stator yoke 18 towards the slot opening. Each auxiliary tooth 34 is located at the middle of a slot 30, between the coils 24 on either side of the slot. The auxiliary teeth 34 have substantially triangular cross-sections when viewed axially. Each auxiliary tooth 34 has a base at its radially outwards end (where it meets the stator yoke 18) and an apex at its radially inwards end (towards the slot opening). The sides of each tooth 34 run at a (non-zero) angle to each other and meet at the apex. Thus, each auxiliary tooth 34 has a width (in a tangential direction) which decreases with increasing distance into the slot 20 from the stator yoke 18.

In the arrangement of FIG. 4, the sides of the auxiliary teeth 34 run alongside (for example, in contact with or in close proximity to) the sides of the coils 24 in the slots. Thus, the sides of an auxiliary tooth 34 are substantially parallel to the sides of the coils 24 in the slot 30. Each auxiliary tooth 34 substantially fills a circumferential gap between the coils 24 of two adjacent teeth 20 over a distance extending part way into the slot 30 from the stator yoke 18. In the example, shown, each auxiliary tooth 34 extends approximately 60% of the way through the stator slot and along approximately 70% of the sides of the coils, although it will be appreciated that other values may be used instead.

Each auxiliary tooth 34 is arranged to be in thermal contact with the coils 24 on either side of the tooth 34. For example, the auxiliary tooth 34 may be in physical contact with the coils 24, or in close proximity to the coils. If desired, a thermally conducting material, such as a thermally conducting (and electrically insulating) sheet or former, may be provided between the auxiliary teeth 34 and the coils 24. As a consequence, heat produced by the coils 24 is conducted by the auxiliary teeth 34 to the stator yoke 18. Heat may be removed from the stator yoke 18 by a cooling jacket and/or other heat dissipating means such as cooling channels through the stator yoke and/or cooling fins.

In the arrangement of FIG. 4, the stator core 16 may be formed from a plurality of stacked laminations. The laminations may be punched from a sheet of raw material such as electrical steel. In this case, the auxiliary teeth 34 may be formed from the same laminations as the stator yoke 18 and the stator teeth 20. This may facilitate manufacture and may allow the auxiliary teeth to be formed from part of the raw material that would otherwise be scrap. Alternatively, if desired, the auxiliary teeth could be made from another material, such as a ceramic material, and be inserted into the stator slots.

In the arrangement of FIG. 4, each tooth supports a single coil and each coil comprises multiple turns of a flat rectangular wire. However, it would also be possible for each tooth to have two or more coils. Furthermore, each coil may have two or more wires. For example, each coil could comprise two or more flat rectangular wires connected in parallel. In addition, while auxiliary teeth with a triangular cross-section are shown, it would also be possible for the auxiliary teeth to have other shaped cross-sections, such as trapezoidal. Various other configurations will be apparent to the skilled person.

In the assembled stator, the coils 24 are connected in an appropriate winding arrangement, such as a star or delta winding arrangement. The coils may be connected using, for example, a connection ring or wires or jump leads. In general, any appropriate winding arrangement may be used. For example, if desired, the winding arrangement described in co-pending United Kingdom patent application number 2207742.4, the subject matter of which is incorporated herein by reference, could be used, although other arrangements could be used instead.

The arrangement of FIG. 4 can allow heat to be conducted away from the coils 24 through the auxiliary teeth 34. Since the coils 24 are typically the hottest part of the machine, this may help to improve the thermal performance of the machine, while maintaining the ease of manufacture associated with an open slot design with pre-formed coils. Furthermore, the auxiliary teeth 34 may help to ensure stability of the coils when the machine is in operation.

FIG. 5 shows part of a stator with a cooling jacket in an embodiment of the disclosure. Referring to FIG. 5, the stator comprises stator yoke 18, a plurality of stator teeth 20 defining stator slots 30, and a plurality of pre-formed coils 24, in a similar way to the stator of FIG. 4. As in the stator of FIG. 4, auxiliary teeth 34 extend from the stator yoke 18 radially inwards into the slots 30. However, in FIG. 5, a cooling jacket 36 extends circumferentially around the outside of the stator yoke 18. The cooling jacket 36 comprises a plurality of cooling channels 38. In this embodiment the cooling channels 38 are spaced circumferentially about the cooling jacket and extend axially through the cooling jacket. Alternatively, they could extend circumferentially through the cooling jacket and/or spiral through the cooling jacket, or have any other appropriate arrangement.

In the arrangement of FIG. 5, the cooling channels 38 are used as conduits for cooling fluid. For example, a liquid coolant such as oil or a water/glycol mix may be pumped through the cooling channels 38. This allows the cooling jacket to draw heat away from the stator core. Heat is drawn from the coils 24, through the teeth 20, through the stator yoke 18 to the cooling jacket 36. Furthermore, in the arrangement of FIG. 5, heat is also drawn from the coils 24 through the auxiliary teeth 34 to the stator yoke 18 and the cooling jacket 36. The auxiliary teeth 34 therefore help to draw additional heat out of the coils, further improving the thermal performance of the machine.

In an alternative arrangement, rather than providing a separate cooling jacket, cooling channels could be provided in the stator core itself. For example, a plurality of cooling channels could be provided in a radially outwards part of the stator yoke. In this case, the location and spacing of the cooling channels is chosen to minimize any impact on the magnetic properties of the stator core. For example, the size of the stator yoke may be increased to accommodate the cooling channels without increasing flux leakage. If desired, other heat dissipation means such as cooling fins could be used instead or as well.

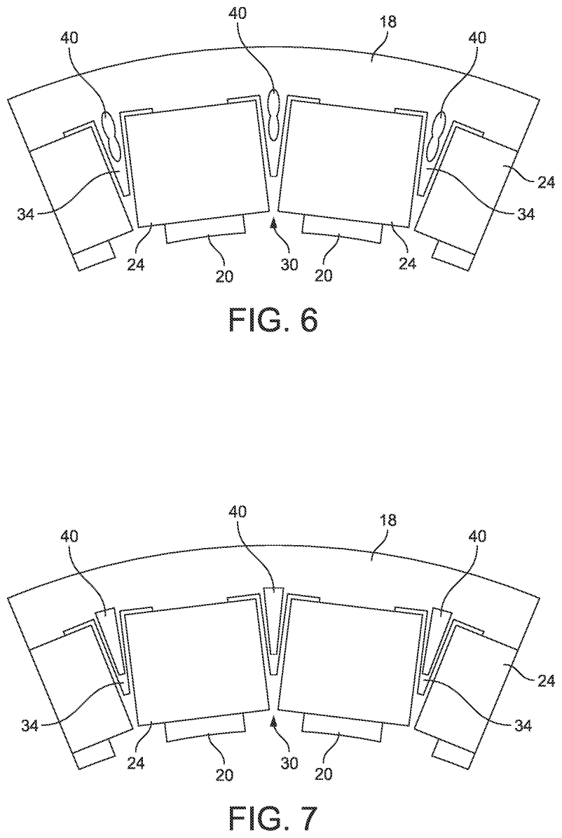

FIG. 6 shows part of a stator in another embodiment of the disclosure. The stator of this embodiment comprises a stator yoke 18, a plurality of stator teeth 20 defining slots 30, and a plurality of pre-formed coils 24. Auxiliary teeth 34 extend from the stator yoke 18 radially inwards into the slots 30, in a similar way to the stator of FIGS. 4 and 5. However, in the stator of FIG. 6, each of the auxiliary teeth 34 is provided with a cooling channel 40. The cooling channels 40 are located at the centre of the auxiliary teeth 34 in a circumferential direction, and towards the base of the auxiliary teeth in a radial direction. The cooling channels 40 extend through the auxiliary teeth 34 in an axial direction.

In the arrangement of FIG. 6, the cooling channels 40 are used as conduits for cooling fluid flowing through the stator core. For example, in one embodiment, a liquid coolant such as oil or a water/glycol mix is pumped through the cooling channels 40. This may be achieved, for example, by providing a pipe at each end of the stator which guides the coolant into and out of the cooling channels. By causing coolant to flow through cooling channels 40 in the auxiliary teeth, further heat can be drawn out of the coils 24, thereby further improving the thermal performance of the machine.

As can be seen from FIG. 6, the cooling channels 40 are provided in parts of the stator core (the auxiliary teeth 34) which are not overlapped by the coils 24. This can allow coolant to be introduced into and removed from the cooling channels 40 without interfering with the coils. The cooling channels 40 are also located close to the coils 24. This reduces the length of the heat transfer path from the coils to the cooling channels, which helps to draw heat away from the coils. Furthermore, it has been found that providing cooling channels in the auxiliary teeth 34 does not significantly impact the magnetic flux in the stator core, which passes principally through the stator yoke 18. Therefore, it has been found that this arrangement can improve the thermal performance of the machine in a way which does not significantly impact its other properties.

If desired, a separate cooling jacket could be provided around the stator yoke, in a similar way to that shown in FIG. 5. Alternatively, or in addition, further cooling channels could be provided for example in a radially outwards part of the stator yoke. However, in some circumstances, providing the cooling channels 40 in the auxiliary teeth 34 in the way shown in FIG. 6 may avoid or reduce the need for a separate cooling jacket or cooling channels in the stator yoke. This may therefore allow a good thermal performance to be achieved while minimising the size of the machine.

In the arrangement of FIG. 6, the cooling channels 40 are located principally in an auxiliary tooth 34, but also extend a small way into the stator yoke 18 in a radial direction. However, the cooling channels 40 may be located in different parts of the auxiliary tooth, and not necessarily extend into the stator yoke. Furthermore, while the cooling channels of FIG. 6 have a figure-of-eight shaped cross-section when viewed axially, they could have any other appropriate cross-section.

FIG. 7 shows part of a stator in another embodiment of the disclosure. The stator of FIG. 7 is similar to that of FIG. 6. However, in the arrangement of FIG. 7 the cooling channels 40 have a substantially triangular cross-section rather than a figure-of-eight cross-section. This may improve the flow of fluid through the cooling channels. In general, the cooling channels could have a cross-section of any appropriate shape, such as triangular, square, rectangular, trapezoidal, circular, oval, or any other appropriate shape or combination of shapes.

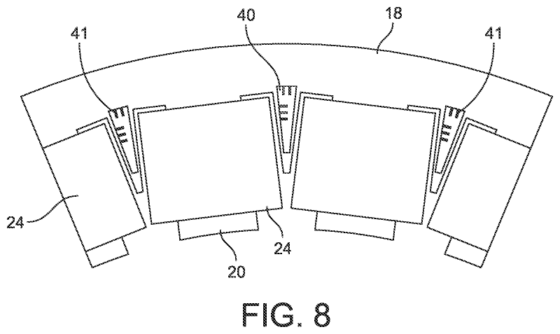

FIG. 8 shows part of a stator in a further embodiment of the disclosure. The stator of FIG. 8 is similar to that of FIG. 7. However, in the arrangement of FIG. 8, fins 41 are provided inside the cooling channels 40 in the auxiliary teeth 34. The fins 41 may be formed as part of the process of stamping laminations, or they may be added later. The fins 41 help with the transfer of heat from the auxiliary teeth to the cooling fluid. The cooling fins may have any appropriate configuration, and may be used with any of the other cooling channels described herein.

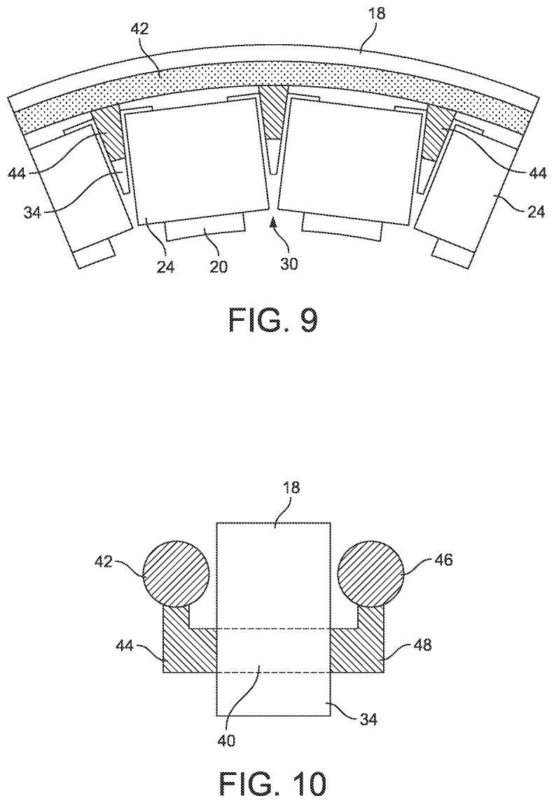

FIG. 9 shows part of a stator and part of a cooling circuit in embodiment of the disclosure. Referring to FIG. 9, the stator comprises a stator yoke 18, a plurality of stator teeth 20 defining stator slots 30, a plurality of pre-formed coils 24, and a plurality of auxiliary teeth 34 extending from the stator yoke 18 radially inwards into the slots 30, in a similar way to the stator of FIGS. 6 to 8. The arrangement of FIG. 9 also includes a pipe 42. The pipe 42 is located adjacent to the stator core in an axial direction, and extends circumferentially around one end face of the stator yoke 18. A plurality of ports 44 extend from the pipe 42 towards the cooling channels in the auxiliary teeth 34. The ports 44 are in fluid communication with the cooling channels (and the pipe), to allow fluid from the pipe 42 to be introduced into the cooling channels, or vice versa. A similar pipe and set of ports are provided on the other side of the stator.

FIG. 10 is a cross-section through part of the stator core in the arrangement of FIG. 9. Referring to FIG. 10, the stator core comprises stator yoke 18 and auxiliary tooth 34 with cooling channel 40. The stator includes pipe 42 which extends circumferentially around one end face of the stator yoke 18. An inlet port 44 is in fluid communication with the pipe 42 and the cooling channel 40 and allows fluid from pipe 42 to be introduced into the cooling channel 40. A similar pipe 46 is provided on the other side of the stator. An outlet port 48 is in fluid communication with the cooling channel 40 and the pipe 46. The outlet port 48 allows fluid from the cooling channel 40 to be collected and fed to the pipe 46.

In operation, a coolant is pumped into the pipe 42 and circulates through the pipe to the inlet ports 44. The coolant passes through the inlet ports 44 and into the cooling channels 40. Coolant which has passed through the cooling channels 40 is collected by the outlet ports 48, and fed to the pipe 46. The pipe 46 collects the coolant from the ports 48 and feeds it back to the cooling circuit.

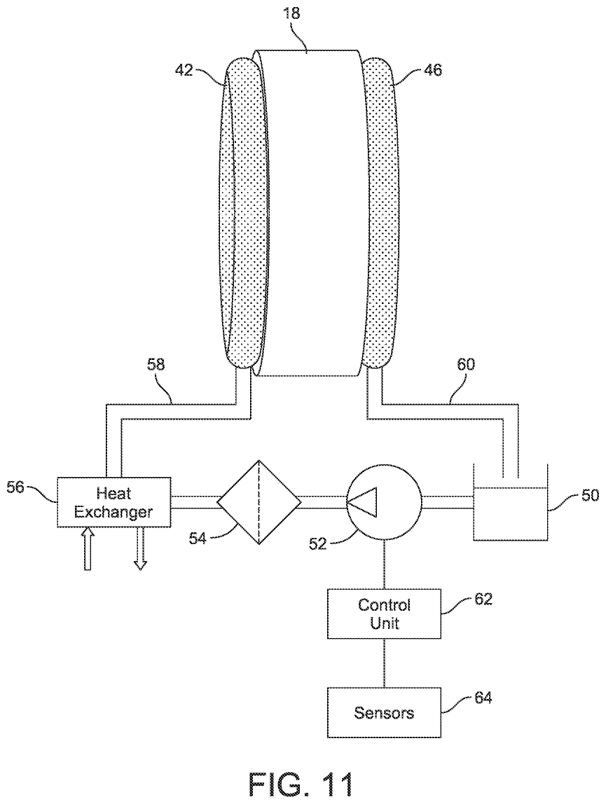

FIG. 11 shows a stator and cooling circuit in an embodiment of the disclosure. The stator comprises a stator core with a stator yoke 18 and a plurality of auxiliary teeth with cooling channels. The stator core may be in any of the forms described above with reference to FIGS. 6 to 10. Referring to FIG. 11, the cooling circuit comprises pipes 42, 46, sump 50, pump 52, filter 54 and heat exchanger 56. The pipes 42, 46 are connected to inlet and outlet ports which are used to introduce coolant into and out of the cooling channels in the auxiliary teeth. The pipe 42 is connected to the heat exchanger 56 by hose 58. The pipe 46 is connected to sump 50 by hose 60. Similar hoses are used to connect the sump 50 to the pump 52, the pump 52 to the filter 54 and the filter 54 to the heat exchanger 56. The arrangement of FIG. 10 also comprises a control unit 62 and sensors 64.

In operation, coolant from the sump 50 is pumped by the pump 52 through the filter 54 to the heat exchanger 56. The filter 54 is used to filter particles from the coolant. The heat exchanger 56 is used to remove heat from the coolant. The coolant is then introduced into the pipe 42 via hose 58. The pipe 42 distributes coolant around the stator and into the inlet ports 44 (see FIGS. 9 and 10). The coolant flows from the inlet ports 44 through the cooling channels in the auxiliary teeth, and is received by outlet ports 48 on the other side of the stator. The coolant is then collected by the pipe 46. Coolant from the pipe 46 flows through the hose 60 and back to the sump 50. In this way, a continuous flow of coolant is provided through the cooling channels in the auxiliary teeth.

In this embodiment the coolant is a heat transfer fluid in the liquid phase. If desired, the coolant may be a lubricating coolant such as engine oil (i.e., oils which are used for lubrication of internal combustion engines) or any other lubricating oil. Alternatively, in some circumstances, a water-based coolant may be used instead. For example, an organic chemical such as glycol (e.g., ethylene glycol, diethylene glycol, or propylene glycol) in water, or any other type of coolant, could be used. In general, any suitable coolant in the liquid and/or gaseous phase could be used.

In this embodiment, the pump 52 is an external pump which is driven electrically by a separate motor. The speed of the pump 52 is controlled by the control unit 62 to ensure that an appropriate amount of coolant is injected into the cooling channels. The control unit 62 may receive inputs from various sensors 64, such as sensors which monitor the speed, load and/or temperature of the electrical machine and/or the level of coolant in the sump 50 or the flow of coolant, and may control the speed of the pump 52 in dependence thereon.

In alternative embodiments, it would be possible for the pump to be driven mechanically, for example by the electrical machine itself. It would also be possible for the sump, pump and/or filter to be located internally within the machine enclosure. Furthermore, if desired, the sump, filter and/or heat exchanger could be dispensed with or replaced with other components.

If desired, the pipes 42, 46 and ports 44, 48 shown in FIGS. 9 to 11 could be part of a cooling circuit which is also used to cool other parts of the stator. For example, the pipes 42, 46 could be connected to a cooling circuit which is also used to pump coolant through a cooling jacket, such as that shown in FIG. 5, or through cooling channels in the stator yoke, or any other part of the electrical machine or other component. In this case, additional cooling via cooling channels in the auxiliary teeth may be achieved without the need to provide a separate cooling circuit.

In an alternative arrangement, rather than using pipes and ports to feed coolant to and from the cooling channels in the auxiliary teeth, other types of conduit could be used as instead or as well. For example, an annular cap could be provided on each side of the stator core to take coolant to and from the cooling channels. Alternatively, a flooded stator arrangement could be used in which the stator housing was used to contain the coolant. If desired, coolant exiting the cooling channels could be collected by a sump at the bottom of the housing.

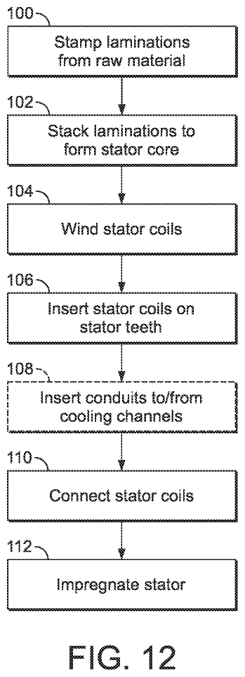

FIG. 12 shows steps which may be carried out to manufacture a stator in one embodiment. In this embodiment, the stator core is formed from a stack of stator laminations. Referring to FIG. 12, in step 100 the laminations are stamped from a sheet of raw material such as electrical steel. Each lamination comprises an annular stator yoke and a plurality of stator teeth. In this embodiment, the auxiliary teeth are produced from the same sheet of raw material as the rest of the stator core, as part of the same stamping processing. This may facilitate manufacture and may allow the auxiliary teeth to be formed from part of the raw material that would otherwise be scrap.

Where cooling channels are provided in the auxiliary teeth, these may also be produced as part of the stamping process. However, it would also be possible for the cooling channels to be formed in the auxiliary teeth after the laminations have been stamped.

In step 102, the laminations are stacked together to form the stator core. Once stacked, the laminations may be held together using a suitable stacking method, such as welding, interlocking, bonding, clamping, riveting, or any other appropriate technique.

In step 104, the stator coils are formed. In one embodiment, each coil is formed by winding a flat rectangular wire into a coil, with each turn of the coil comprising a single width of the wire. The coils may be for example as described above with reference to FIG. 2. If desired, the coils may be wound on bobbins or formers which can be slid onto the teeth together with the coils.

In step 106, the coils are inserted onto the stator teeth. This is achieved by sliding the pre-formed coils radially onto the teeth. If the coils are on formers, then the formers may be slid onto the teeth together with the coils. Alternatively, the coils may be slid directly onto the teeth, or a barrier such as a former or electrically insulating paper may be inserted on the teeth prior to inserting the coils.

Where the auxiliary teeth have cooling channels, then in step 108 suitable conduits are provided to feed coolant into and out of the cooling channels. For example, the pipes 42, 46 and ports 44, 48 described above with reference to FIGS. 9 to 11 may be added to the stator. The pipes 42, 46 may be attached to the stator core, for example, using clips. The ports may be adhered to the stator core using adhesive or attached in any other way. If desired, part of the ports may be inserted into the cooling channels.

In step 110, the coils are connected in an appropriate winding arrangement. In one embodiment, this is achieved using a connection ring. The connection ring is positioned adjacent to the stator yoke in an axial direction. The connection ring has a body which is moulded from an electrically non-conductive material such as a plastic resin. Inside the body are three electrically conductive rings. Each of the conductive rings provides one of the three phases of the electrical machine. The terminals of the coils are then connected to the appropriate conductive ring, in order to achieve the desired winding arrangement. The conductive rings are connected to terminals in a terminal block. The terminal block provides the electrical connections for the stator (which may be high voltage or low voltage).

If desired, one of the pipes 42, 46 show in FIGS. 9 to 11 (or any other suitable conduit) could be provided as part of the connection ring. This may facilitate manufacture, by allowing a single part to fulfil both functions.

Alternatively, rather than using a connection ring, it would also be possible to connect the coils using any other appropriate electrical connectors such as wires or jump leads.

In step 112, the stator is impregnated. For example, the stator may be impregnated with a suitable potting compound such as epoxy resin. This helps to ensure the stability of the assembled stator. Furthermore, the potting compound may help to ensure that there are no leaks in the coolant flow paths, for example, between the ports and the cooling channels.

If desired, the steps shown in FIG. 12 may be carried out in a different order. Furthermore, some of the steps may be dispensed with, and other steps may be added.

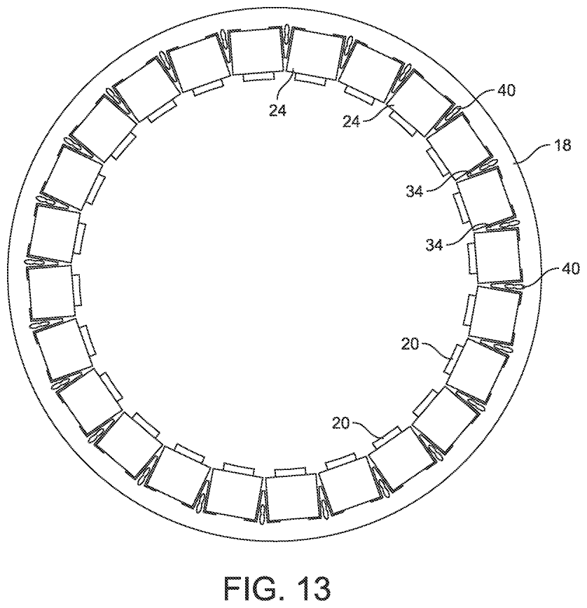

FIG. 13 shows an example of a partially assembled stator. The stator core comprises a stator yoke 18 and twenty-four stator teeth 20. Each of the stator teeth is wound with a stator coil 24. The stator core also includes twenty-four auxiliary teeth 34 which extend into the stator slots between the coils of adjacent teeth. Each of the auxiliary teeth has a cooling channel 40. In this example, the stator is shown without a cooling circuit, so that the cooling channels 40 can be seen. However, it will be appreciated that, in the assembled stator, suitable conduits are provided to supply coolant to and from the cooling channels.

In the arrangement of FIG. 13, the stator comprises twenty-four stator teeth 20 and twenty-four auxiliary teeth 34. However, it will be appreciated that any appropriate number of stator teeth and auxiliary teeth may be provided. If desired, the number of auxiliary teeth may be different from the number of stator teeth. The auxiliary teeth may be provided without cooling channels, or else some but not all of the auxiliary teeth may have cooling channels. If desired, other cooling channels could be provided in the stator core.

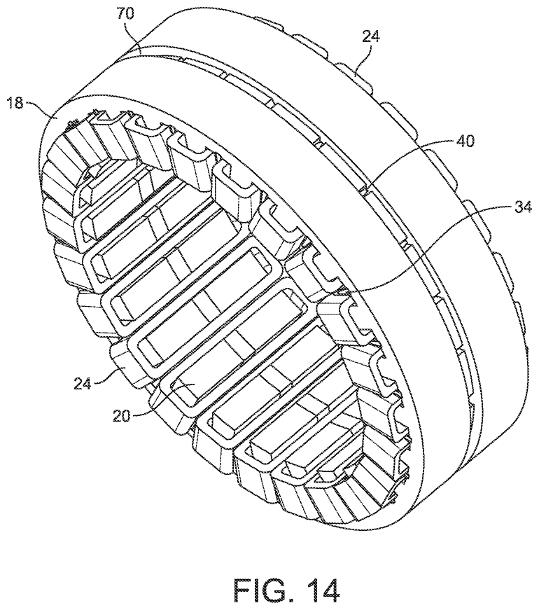

FIG. 14 shows part of a stator in another embodiment of the disclosure. The stator of this embodiment comprises a stator yoke 18, a plurality of stator teeth 20 defining stator slots, a plurality of pre-formed coils 24 and a plurality of auxiliary teeth 34 extending from the stator yoke 18 radially inwards into the stator slots. Each of the auxiliary teeth 34 is provided with a cooling channel 40, in a similar way to the stators of FIGS. 6 to 10 and 12. However, in the stator of FIG. 14, a cooling passage 70 is provided in the stator core pack. The cooling passage 70 is in the form of a U-shaped trough which runs circumferentially around the outside of the stator yoke. In this embodiment, the cooling passage is located at the centre of the stator yoke axially, although it could be at other axial locations. The cooling passage 70 is in fluid communication with the cooling channels 40 in the auxiliary teeth. The cooling passage 70 may be formed by providing a group of laminations at the centre of the stator core in which the diameter of the stator yoke is less than that of the other laminations.

In the arrangement of FIG. 14, the cooling passage 70 is used to carry coolant circumferentially around the stator core and into the cooling channels 40. An outer wall of the cooling passage may be formed by the stator housing, in order to form a conduit for carrying the fluid. Alternatively, a pipe could be located in the cooling passage, and coolant could be introduced from the pipe into the cooling channels 40 using ports in a similar manner to that shown in FIG. 10 (although in this case coolant would be introduced from the radially outwards side rather from the axially outwards side). Coolant may be introduced into the cooling passage 70, for example, using a hose connected to a cooling circuit, in a similar manner to that of FIG. 11.

The cooling passage 70 of FIG. 14 is used to introduce coolant into the cooling channels 40 at the centre of the stator core, axially. The coolant then flows axially through the cooling channels in each direction from the centre to the two ends of the stator. Coolant exiting the cooling channels 40 at either end of the stator may be collected by a sump at the bottom of the housing and re-introduced into the cooling circuit. Alternatively, the coolant could be collected by ports and a pipe in a similar way to that shown in FIG. 11.

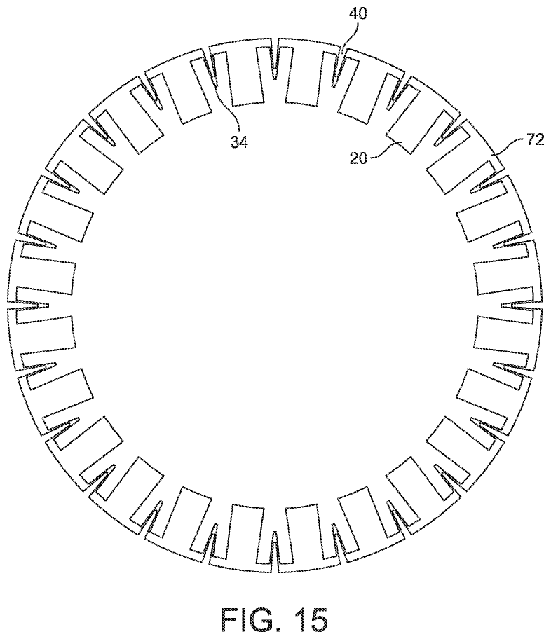

FIG. 15 shows an example of a stator lamination which can be used to form a cooling passage in one embodiment. Referring to FIG. 15, the lamination comprises yoke portions 72, a plurality of stator teeth 20 defining stator slots, and a plurality of auxiliary teeth 34 extending from the yoke portions 72 radially inwards into the stator slots. Each of the auxiliary teeth 34 is provided with a cooling channel 40. In the arrangement of FIG. 15, the cooling channels 40 are open on their radially outwards side. This is achieved by reducing the diameter of the stator yoke, in comparison to that of the laminations elsewhere in the stator core. The laminations may be stamped from a sheet of raw material such as electrical steel. A group of laminations in the form shown in FIG. 15 is provided at the centre of the stator core, axially, in order to form the cooling passage 70.

In practice, laminations with the shape shown in FIG. 15 may not contribute significantly to the electromagnetic performance of the machine. Thus, in another embodiment, rather than using a group of laminations to form the cooling passage, a separate solid ring of electrically and/or magnetically non-conductive material could be used instead.

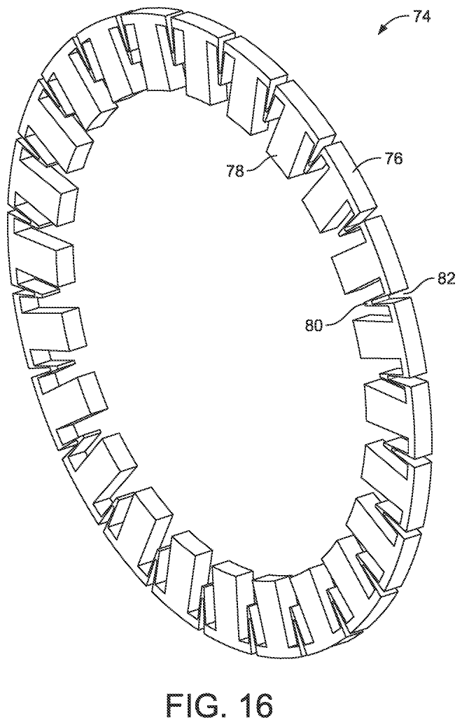

FIG. 16 shows an example of a solid ring which may be used to form the cooling passage 70 of FIG. 14. Referring to FIG. 16, the ring 74 has yoke portions 76, a plurality of teeth 78 defining stator slots, and a plurality of auxiliary teeth 80 extending from the yoke portions 76 radially inwards into the stator slots. Each of the auxiliary teeth 80 is provided with a cooling channel 82. The cooling channels 82 are open on their radially outwards side. The yoke portions 76, teeth 78, auxiliary teeth 80 and cooling channels 82 are substantially the same in axial cross-section as the lamination shown in FIG. 15. However, in FIG. 16, the ring 74 has a depth which is equivalent to the width of the cooling passage 70 in an axial direction.

The solid ring 74 shown in FIG. 16 may be formed from an electrically and magnetically non-conductive material such as a thermoplastic polymer. For example, in one embodiment, a polyether ether ketone (PEEK) material could be used, although other materials could be used instead. The solid ring 74 may be manufactured, for example, using injection moulding or any other suitable technique. The solid ring 74 is provided at the centre axially of the stator core, with stator laminations on either side. Alternatively, it would be possible for the solid ring to be provided at other axial locations and/or a plurality of rings to be used in order to form a plurality of cooling channels.

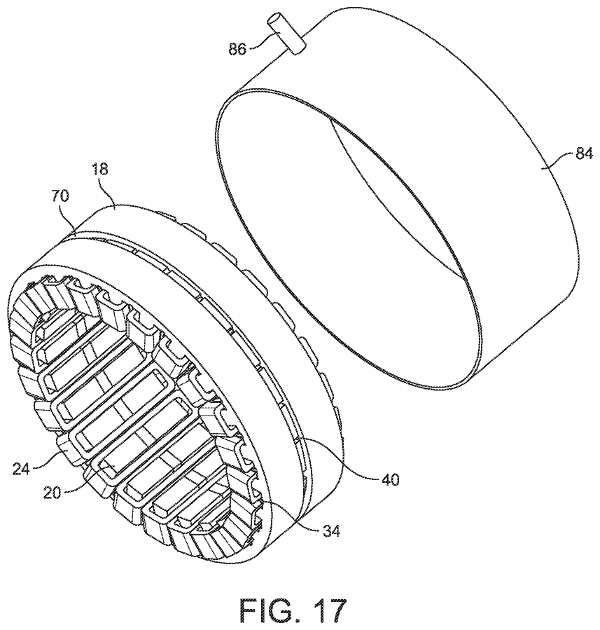

FIG. 17 illustrates how a stator housing can be used to form an outer wall of the cooling passage. Referring to FIG. 17, the stator is arranged to be accommodated inside a stator housing 84. The stator housing 84 is cylindrical and fits around the stator yoke 18. When in place, an inside wall of the stator housing 84 forms an outer wall of the cooling passage 70. A port 86 is provided for introducing cooling into the cooling passage 70 through the stator housing 84. The port 86 is connected to a cooling circuit similar to that illustrated in FIG. 11.

In operation, coolant is introduced into the cooling passage 70 through the port 86. Coolant then flows circumferentially around the stator yoke through the cooling passage 70. When the coolant encounters a cooling channel 40 in an auxiliary tooth 34, some of the coolant flows axially inwards into the cooling channel 40. Coolant in the cooling channel 40 then flows from the centre of the cooling channel, axially outwards in both directions. The coolant exits the cooling channels at both ends, axially, of the stator. Coolant exiting the cooling channels is collected in a sump and re-introduced into the cooling circuit. Alternatively, a pipe and a plurality of ports could be used to collect the coolant, in a similar way to that shown in FIGS. 9 to 11.

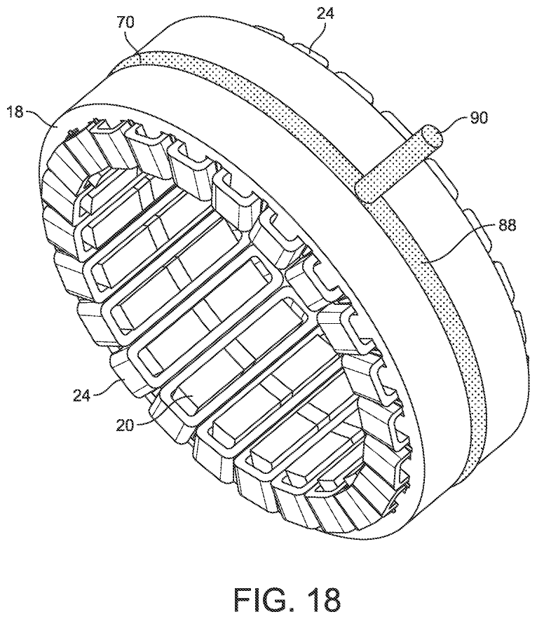

FIG. 18 shows an alternative arrangement in which a pipe is located in the cooling passage. Referring to FIG. 18, the pipe 88 is located at least partially inside cooling passage 70, and runs circumferentially around the stator yoke 18. A port 90 is provided for introducing cooling into the pipe 88. The pipe 88 also comprises a plurality of ports (not visible in FIG. 18) for introducing coolant from the pipe 88 into the cooling channels in the auxiliary teeth. The port 90 is connected to a cooling circuit similar to that illustrated in FIG. 11.

In operation, coolant is introduced into the pipe 88 through the port 90. Coolant then flows circumferentially around the stator yoke through the pipe 88. When the coolant encounters a cooling channel 40 in an auxiliary tooth 34, some of the coolant flows radially inwards into the cooling channel 40. Coolant in the cooling channel 40 then flows from the centre of the cooling channel, axially outwards in both directions. The coolant exits the cooling channels at both ends, axially, of the stator, and may be collected using for example a sump or a pipe and a plurality of ports.

It will therefore be appreciated that embodiments of the disclosure provide a stator core integrated in-slot cooling design for electrical machines with concentrated windings. The stator has small auxiliary teeth in the middle of the slots. Cooling channels may be provided in the auxiliary teeth. Typically, most of heat is generated in the windings and the stator teeth. With a shorter heat transfer path from the windings to cooling channels, a better heat dissipation capability can be achieved, which in turn can improve the torque/power density of the machine. This is particularly suitable for electric machines with flat rectangular wire concentrated windings where the middle of slot is normally left empty, and thus the proposed design need not sacrifice the slot fill factor.

While the above embodiments relate to a rotating electrical machine, the same concepts could be applied to a linear machine. A linear machine may be achieved for example by splitting the stator along radial direction and unfolding it along the circumferential direction.

Embodiments of the disclosure have been described above by way of example only, and variations in detail are possible. For example, rather than using a single coil on each stator tooth, a plurality of coils could be provided on each tooth. Rather than using coils with a single wire, each coil could comprise a plurality of wires (for example, a plurality of flat rectangular wires). Rather than using coils with a uniform thickness, the coils may have a variable thickness. Rather than using teeth with parallel sides, it would be possible for the teeth to be tapered. In this case, the internal diameter of the coils may have a corresponding taper. The stator may have any appropriate number of stator teeth and auxiliary teeth, and may have any appropriate number of poles and phases. Various other modifications will be apparent to the skilled person within the scope of the claims.

What is claimed is:

1. A stator for an electrical machine, the stator comprising:
a stator yoke;
a plurality of stator teeth extending radially inwards from the stator yoke, the stator teeth defining stator slots for stator windings;
a plurality of auxiliary teeth extending radially inwards from the stator yoke into the stator slots, wherein at least some of the auxiliary teeth comprise cooling channels; and
a conduit arranged to carry coolant circumferentially around the stator and into the cooling channels in the auxiliary teeth.

2. The stator according to claim 1, wherein:
the stator windings comprise a plurality of pre-formed coils;
each coil is arranged to be slid onto one of the stator teeth; and
each auxiliary tooth extends radially inwards from the stator yoke into a stator slot between the coils of two adjacent stator teeth.

3. The stator according to claim 1, wherein the auxiliary teeth have a width in a tangential direction which decreases with increasing distance into the stator slot from the stator yoke.

4. The stator according to claim 1, wherein each auxiliary tooth substantially fills a gap between the stator windings of two adjacent teeth.

5. The stator according to claim 1, wherein the stator windings comprise pre-formed coils of rectangular wire.

6. The stator according to claim 5, wherein each coil comprises a plurality of turns of rectangular wire, and each turn comprises a single width of rectangular wire.

7. The stator according to claim 1, wherein the auxiliary teeth are arranged to conduct heat from the stator windings to the stator yoke.

8. The stator according to claim 1, wherein the cooling channels run axially through the auxiliary teeth.

9. The stator according to claim 1, wherein the cooling channels are arranged to convey a liquid coolant.

10. The stator according to claim 1, wherein the conduit comprises a pipe and a plurality of ports.

11. The stator according to claim 1, wherein the conduit comprises a cooling passage in the stator yoke.

12. The stator according to claim 11, wherein the cooling passage runs circumferentially around the outside of the stator yoke.

13. The stator according to claim 11, wherein the cooling passage is located at or towards the centre, axially, of the stator yoke.

14. The stator according to claim 11, wherein the cooling passage is an annular trough in the outside of the stator yoke.

15. The stator according to claim 11, wherein the stator comprises a plurality of stacked stator laminations, and the cooling passage is formed by providing a group of stator laminations with an outside diameter which is less than that of other stator laminations.

16. The stator according to claim 11, wherein the stator comprises a plurality of stacked stator laminations, and the cooling passage is formed by providing a ring of material between two groups of stator laminations, the ring of material having an outside diameter which is less than that of the laminations.

17. The stator according to claim 11, wherein the cooling passage is arranged to carry coolant circumferentially around the stator yoke and the cooling channels are arranged to carry coolant axially through the auxiliary teeth.

18. The stator according to claim 1, the stator comprising a plurality of stacked laminations, wherein the auxiliary teeth are formed from the same laminations as the stator yoke.

19. An electrical machine comprising a stator and a rotor, the stator comprising:
a stator yoke;
a plurality of stator teeth extending radially inwards from the stator yoke, the stator teeth defining stator slots for stator windings;
a plurality of auxiliary teeth extending radially inwards from the stator yoke into the stator slots, wherein at least some of the auxiliary teeth comprise cooling channels; and
a conduit arranged to carry coolant circumferentially around the stator and into the cooling channels in the auxiliary teeth,
the electrical machine further comprising a cooling circuit arranged to circulate coolant through the conduit and the cooling channels in the auxiliary teeth.

20. A method of manufacturing a stator for an electrical machine, the method comprising:
forming a stator core, the stator core comprising a stator yoke, a plurality of stator teeth defining stator slots, and a plurality of auxiliary teeth, each auxiliary tooth extending radially inwards from the stator yoke into a stator slot, wherein at least some of the auxiliary teeth comprise cooling channels; and
providing a conduit arranged to carry coolant circumferentially around the stator and into the cooling channels in the auxiliary teeth.
